(19) United States
(12) Patent Application Publication
(10) Pub. No.: US 2015/0188699 A1
(43) Pub. Date: Jul. 2, 2015

(54) METHOD AND APPARATUS FOR ESTABLISHING SECURE SESSION BETWEEN CLIENT AND SERVER

(71) Applicant: SAMSUNG SDS CO., LTD., Seoul (KR)

(72) Inventors: Ki-Woon SUNG, Seoul (KR); Sang-Bum KIM, Youngin-Si (KR); Young-Tai NA, Seongnam-Si (KR); Soo-Hwan PARK, Seoul (KR); Bo-Ri OH, Seoul (KR); Sang-Bum CHO, Seoul (KR); Jae-Ho YANG, Anyang-si (KR)

(73) Assignee: SAMSUNG SDS CO., LTD., Seoul (KR)

(21) Appl. No.: 14/582,589

(22) Filed: Dec. 24, 2014

(30) Foreign Application Priority Data
Dec. 30, 2013 (KR) 10-2013-0166682

(51) Int. Cl. H04L 9/08; H04L 29/06

(52) U.S. Cl. CPC H04L 9/0838; H04L 63/0838; H04L 67/42; H04L 9/0869

(57) ABSTRACT

A method of establishing a secure session between a client and a server by a network node accessed by the client and the server includes receiving, by the network node, a client side random number generated by the client; generating, by the network node, a server side random number in response to reception of the client side random number; transmitting, by the network node, the server side random number to the client such that the client calculates a secret key of a secure session to be established between the client and the server; receiving, by the network node, a client side key, used by the client to calculate the secret key, from the client; and transmitting, by the network node, the client side random number, the server side random number, and the client side key to the server such that the server calculates the secret key.

### CROSS-REFERENCE TO RELATED APPLICATION

This application claims priority to and the benefit of Korean Patent Application No. 10-2013-0166682, filed on Dec. 30, 2013, the disclosure of which is incorporated herein by reference in its entirety.

### BACKGROUND

1. Field

Embodiments of the present disclosure relate to a method and device for establishing a secure session, and more specifically, to an overlay networking technique that accelerates data transmission using a secure session between a client and a server.

2. Discussion of Related Art

A mechanism for reliable data transmission may require techniques for preventing an increase in latency. However, a mechanism for transmitting real time multimedia data (for example, audio and video generated in real time or a combination thereof) uses an approach for guaranteeing low transmission latency of such data that may be different from an approach of a mechanism for transmitting pre-stored data (for example, a large file) to a storage device.

The pre-stored data may be transmitted by a transmission method of optimizing a bandwidth utilization rate based on a maximum throughput (for example, based on a bandwidth delay product (BDP)) of a transmission channel. On the other hand, in general, an amount (for example, audio data of 20 to 40 kbps and/or video data of 700 to 1400 kbps) of real time multimedia data generated per unit time is much smaller than a maximum throughput of the transmission channel and needs to be transmitted with a minimum latency when such multimedia data is generated. For example, a speech recognition service (for example, Siri and S-Voice) based on speech detected in a computing device such as a smartphone may require an improved technique for low transmission latency of data representing the speech.

In particular, in such real time multimedia data transmission, a time required for establishing a new session or re-establishing an already established session in response to the generated multimedia data consumes a considerable amount of time in a total time taken for transmitting the multimedia data. Therefore, when a time taken for establishing a session in a service (for example, the above-described speech recognition service) that handles real time multimedia data in a scale of the Internet increases, quality of the service may be far worse than expected. However, a time for establishing/re-establishing a session is easily ignored in an approach for increasing transmission efficiency of stored data. This is because, as an amount of data to be transmitted increases, a ratio of a time taken for establishing/re-establishing a session for such transmission to a time taken for actually transmitting the data increases.

Further, in a multimedia service (for example, the above-described speech recognition service) having security-related requirements such as privacy protection, multimedia data should be transmitted through a secure channel (for example, a secure sockets layer (SSL)/a transport layer security (TLS) secure channel). Accordingly, a decrease in a time for establishing/re-establishing a secure session for transmitting real time multimedia data may be useful to prevent a transmission delay.

### SUMMARY

In a network including a client and a server, an increase in latency due to a round trip time (RTT) and a packet loss is inevitable in direct transport of data between the client and the server, but an overlay networking technique may obtain improved transmission efficiency by disposing at least one intermediate network node or overlay hop between the client and the server.

In some overlay networking techniques in the related art, a transport layer and/or a lower layer (s) of the transport layer (hereinafter referred to as “bypass overlay techniques”) is changed. According to such techniques, use of an overlay network including geographically distributed nodes is transparent to a data transmission system and a data reception system that operates in an upper layer (for example, an application layer) of a transport layer. In such an overlay network, based on a message exchanged in the upper layer of the transport layer, a secure session (for example, an SSL session or a TLS session) is established. This message may not be recognized in a layer for implementing the overlay network. In particular, since a random number or a key generated by each of the client and the server is not generated in advance or detected by the overlay hop, the overlay hop may not be used in place of such an exchange of the random number or the key. Therefore, it is difficult to decrease the time for establishing a secure session.

In some overlay networking techniques in the related art, a secure session (for example, an SSL session or a TLS session) between a client and an overlay hop, and another secure session (for example, another SSL session or another TLS session) between the overlay hop and a server are established (hereinafter referred to as “session separating techniques”). Since separate session keys are assigned to two secure sessions, the overlay hop should perform decryption using one of the two session keys and encryption using the other session key. In particular, when the overlay hop supports a large number of clients, an overhead (for example, a CPU usage) caused by such decryption and encryption may become a significant burden on the overlay hop. In order to decrease the overhead, a hardware-based encryption/decryption device may be used. However, it is actually difficult to modify and customize the device to connect with other overlay hop. In addition, performing decryption in the overlay hop means that plaintext is stored in the overlay hop. As a result, the overlay hop has vulnerability from a security perspective.

Embodiments to be disclosed provide a new overlay networking technique that accelerates data transmission using the secure session between the client and the server.

According to an aspect of the present disclosure, there is provided a method of establishing a secure session, including: receiving a client side random number generated by a client in a network node accessed by the client and a server; generating a server side random number in the network node in response to the reception of the client side random number; transmitting the server side random number from the network node to the client such that the client calculates a secret key of a secure session to be established between the client and the server; receiving a client side key used for calculating the secret key in the network node; and transmitting the client side random number, the server side random number and the client side key from the network node to the server such that the server calculates the secret key.

The method may further include calculating the secret key based on the client side random number, the server side random number and the client side key in the network node.

The server side random number may be transmitted from the network node to the server through another secure session that is established between the network node and the server in advance.

The server side random number may be encrypted as a public key of the server by the network node and then transmitted from the network node to the server.

The server side random number may not be encrypted and transmitted from the network node to the server through a non-secure session established between the network node and the server.

The client side key may be encrypted by the client as a public key of the server.

According to another aspect of the present disclosure, there is provided a method of establishing a secure session, including: receiving a client side random number generated by a client in a network node accessed by the client and a server; deriving a server side random number from one time password (OTP) in the network node in response to the reception of the client side random number; transmitting the server side random number from the network node to the client such that the client calculates a secret key of a secure session to be established between the client and the server; transmitting a notification indicating derivation of the server side random number from the network node to the server such that the server generates the server side random number from an OTP that is the same as the OTP; receiving a client side key used for calculating the secret key in the network node; and transmitting the client side random number and the client side key from the network node to the server such that the server calculates the secret key.

The method may further including calculating the secret key based on the client side random number, the server side random number and the client side key in the network node.

The notification may be transmitted from the network node to the server through another secure session that is established between the network node and the server in advance.

The notification may be encrypted as a public key of the server by the network node and then transmitted from the network node to the server.

The notification may not be encrypted and transmitted from the network node to the server through a non-secure session established between the network node and the server.

The client side key may be encrypted by the client as a public key of the server.

According to still another aspect of the present disclosure, there is provided a device for establishing a secure session that accesses a client and a server and establishes a secure session between the client and the server, the device including: a random number generator configured to generate a server side random number in response to reception of a client side random number generated by the client; and a communication interface configured to receive the client side random number, transmit the server side random number to the client such that the client calculates a secret key of a secure session to be established between the client and the server, receive a client side key used for calculating the secret key, and transmit the client side random number, the server side random number and the client side key such that the server calculates the secret key.

The device may further include a secret key calculator configured to calculate the secret key based on the client side random number, the server side random number and the client side key.

The communication interface may transmit the server side random number to the server through another secure session that is established between the network node and the server in advance.

The communication interface may encrypt the server side random number as a public key of the server and then transmit the result to the server.

The communication interface may transmit the server side random number that is not encrypted to the server through a non-secure session established between the device and the server.

The client side key may be encrypted by the client as a public key of the server.

According to yet another aspect of the present disclosure, there is provided a device for establishing a secure session that accesses a client and a server and establishes a secure session between the client and the server, the device including: a random number generator configured to derive a server side random number from one time password (OTP) in response to reception of a client side random number generated by the client; and a communication interface configured to receive the client side random number, transmit the server side random number to the client such that the client calculates a secret key of a secure session to be established between the client and the server, transmit a notification indicating derivation of the server side random number to the server such that the server generates the server side random number from an OTP that is the same as the OTP, receive a client side key used for calculating the secret key, and transmit the client side random number and the client side key such that the server calculates the secret key.

The device may further include a secret key calculator configured to calculate the secret key based on the client side random number, the server side random number and the client side key.

The communication interface may transmit the notification to the server through another secure session that is established between the device and the server in advance.

The communication interface may encrypt the notification as a public key of the server and then transmit the result to the server.

The communication interface may transmit the notification that is not encrypted to the server through a non-secure session established between the device and the server.

The client side key may be encrypted by the client as a public key of the server.

In yet another aspect of the present disclosure, there is provided a computer readable storage medium storing a computer program to execute any of the methods.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram illustrating a network environment according to an exemplary embodiment;

FIGS. 2A and 2B are diagrams illustrating a process of establishing a secure session between a client and a server according to an exemplary embodiment;

FIG. 3 is a diagram illustrating a process of establishing a secure session between a client and a server according to an exemplary embodiment; and

FIG. 4 is a block diagram illustrating a device for establishing a secure session between a client and a server according to an exemplary embodiment.

### DETAILED DESCRIPTION OF EXEMPLARY EMBODIMENTS

Hereinafter, detailed embodiments of the present disclosure will be described with reference to the drawings. The following detailed description is provided to help comprehensive understanding of methods, devices and/or systems described in this specification. However, these are only examples, and the present disclosure is not limited thereto.

In descriptions of the disclosure, when it is determined that detailed descriptions of related well-known functions unnecessarily obscure the gist of the disclosure, detailed descriptions thereof will be omitted. Some terms described below are defined by considering functions in the disclosure and meanings may vary depending on, for example, a user or operator's intentions or customs. Therefore, the meanings of terms should be interpreted based on the scope throughout this specification. The terminology used in detailed description is provided to only describe embodiments of the present disclosure and not for purposes of limitation. Unless the context clearly indicates otherwise, the singular forms include the plural forms. It will be understood that the terms “comprises” or “includes” when used herein, specify some features, numbers, steps, operations, elements, and/or combinations thereof, but do not preclude the presence or possibility of one or more other features, numbers, steps, operations, elements, and/or combinations thereof in addition to the description.

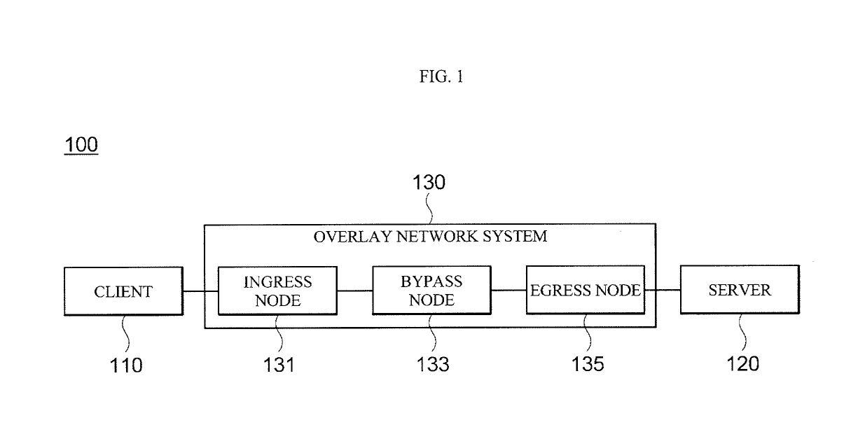

FIG. 1 is a block diagram illustrating a network environment according to an exemplary embodiment.

As illustrated in FIG. 1, a network environment 100 includes a client 110, a server 120 and an overlay network system 130 provided between the client 110 and the server 120. Data transmitted between the client 110 and the server 120 passes through the overlay network system 130. For example, when a speech recognition service may be provided from the server 120 to the client 110, the speech recognition service may be performed using a method in which the client 110 transmits data representing speech to the server 120 through the overlay network system 130, and the server 120 recognizes speech from the data and provides other data based on the recognized speech to the client 110 through the overlay network system 130.

The overlay network system 130 is configured to accelerate data transmission between the client 110 and the server 120. Specifically, the overlay network system 130 may include intermediate network nodes such as an ingress node (IN) 131 and an egress node (EN) 135. For example, data is input from the client 110 to the overlay network system 130 through the IN 131. The data is output from the overlay network system 130 to the server 120 through the EN 135. Further, as an example, the overlay network system 130 may further include a bypass node (BN) 133 as an additional intermediate network node. The BN 133 delivers the data input to the IN 131 to the EN 135. Although not illustrated in FIG. 1, as another example, at least one other bypass node may be provided between the BN 133 and the EN 135 and relay communication between the BN 133 and the EN 135.

The IN 131 may be disposed in the network environment 100 such that a link between the IN 131 and the client 110 has a smaller round trip time and a smaller packet loss than a link between the IN 131 and the EN 135. In addition, the EN 135 may be disposed geographically closer to the server 120.

In particular, according to a predetermined management policy, the IN 131 may store a copied certificate that is the same as a certificate of the server 120 and have a private key that is the same as the server 120. Further, the IN 131 may generate a secure key (for example, a master secret key defined in an SSL protocol) for a secure session (for example, an SSL session) between the client 110 and the server 120. As a result, the client 110 may maintain compliance with security-related standards without separate modification and increase a rate of data transmission between the client 110 and the server 120. In exemplary embodiments, latency taken for establishing a secure session (for example, an SSL session) between the client 110 and the server 120 may decrease. In such embodiments, the IN 131 serves as a proxy of the server 120 for the client 110, and enables the client 110 and the server 120 to generate the same master secret key. The IN 131 need not establish separate secure sessions (for example, SSL sessions) with the client 110 and the server 120. As an example, the IN 131 may generate a server side random number used for generating the master secret key in place of the server 120 and transmit the result to the client 110 and the server 120. As another example, a mechanism in which the IN 131 and the server 120 may obtain the same OTP (one time password) may be used. When such a mechanism is implemented between the IN 131 and the server 120, the IN 131 may derive the server side random number from the OTP, transmit the result to the client 110, and enable the server 120 to derive the same server side random number from the same OTP.

Network nodes (that is, the client 110, the server 120 and intermediate network nodes of the overlay network system 130) in the network environment 100 each may be implemented in a computing device including at least one processor and a computer readable recording medium connected to the processor. The computer readable recording medium may be provided inside or outside the processor, and be connected to the processor using various well-known methods. The processor in the computing device may cause each computing device to be operated according to a predetermined embodiment described herein. For example, such a processor may execute an instruction stored in the computer readable recording medium. When the instruction stored in the computer readable recording medium is executed by the processor, the computing device may perform operations according to the predetermined embodiment described herein.

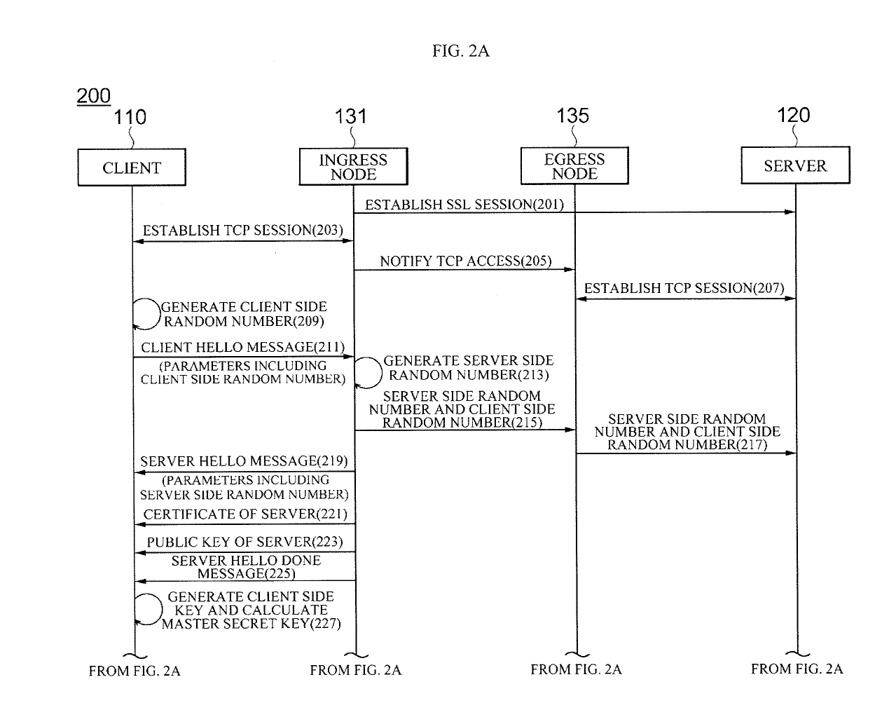

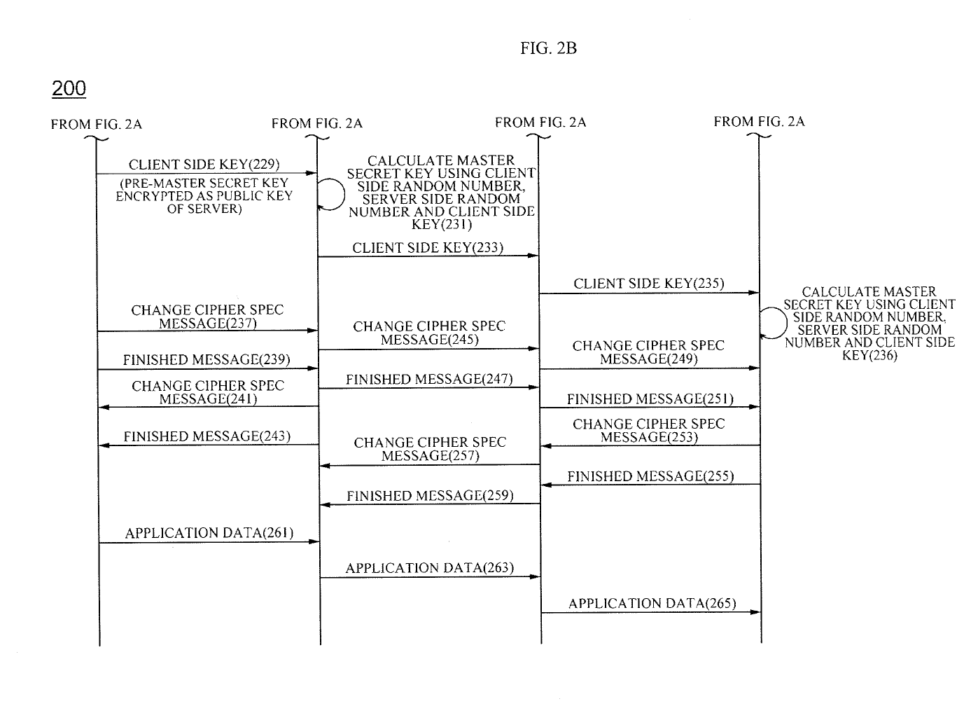

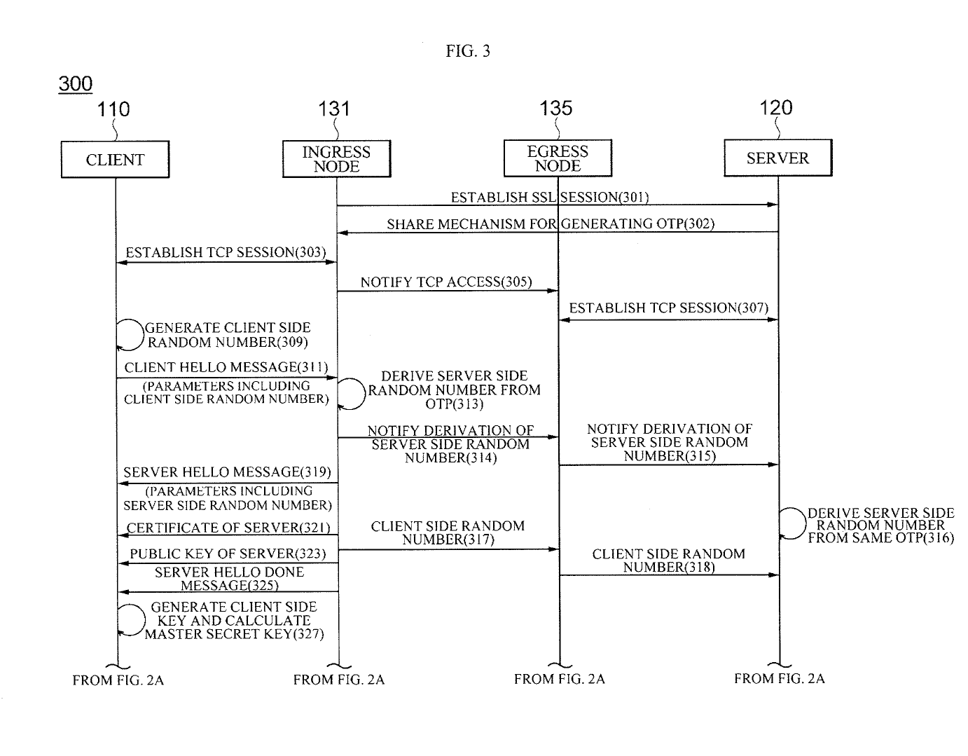

FIGS. 2A and 2B illustrate a process of establishing a secure session between a client and a server according to an exemplary embodiment.

An exemplary process 200 includes operations performed by the client 110, the server 120, the IN 131 and the EN 135. Needless to say, unlike illustrations in FIGS. 2A and 2B, the IN 131 and the server 120 may directly exchange a signal without the EN 135.

The operations of the process 200 establish an SSL session between the client 110 and the server 120. It can be understood that operations similar to the operations of the process 200 may establish a secure session (for example, a TLS session) between the client 110 and the server 120 other than the SSL session.

In operation 201, a secure session between the IN 131 and the server 120 is established. For example, as illustrated in FIG. 2A, the EN 135 may relay a request and/or data from the IN 131 to the server 120 using a method in which the IN 131 establishes a secure session with the EN 135 and the EN 135 establishes a secure session with the server 120. As another example, the IN 131 may directly establish a secure session with the server 120.

While the secure access between the IN 131 and the server 120 is established, the server 120 may provide a cipher suite list stored in the server 120 to the IN 131. The cipher suite list indicates cipher suites supported by the server 120. In addition, the cipher suite list may be a list in which priorities of cipher suites that can be used by the server 120 are assigned. The IN 131 may use the cipher suite list to negotiate a cipher-spec for an SSL session with the client 110.

FIG. 2A illustrates that access established between the IN 131 and the server 120 accompanies an SSL session. Alternatively, the access established between the IN 131 and the server 120 may accompany a general non-secure session (for example, a TCP session). The IN 131 may transmit a request and/or data without encryption to the server 120 through the non-secure session or encrypt the request and/or data as a public key of the server 120, and transmit the result to the server 120 through a general session.

In operation 203, a TCP session between the client 110 and the IN 131 is established. For example, establishment of the TCP session may be performed through a TCP handshake (for example, a handshake in which the client 110 transmits a SYN to the IN 131, the IN 131 transmits a SYN-ACK to the client 110 in response thereto, and the client transmits an ACK to the IN 131) between the client 110 and the IN 131. The TCP session is only an example, and a session based on anther protocol of the transport layer may be established between the client 110 and the IN 131.

In operation 205, the IN 131 notifies the EN 135 that the client 110 has accessed the IN 131 based on TCP.

In operation 207, in response to reception of such a notification, the EN 135 obtains the TCP session established between the EN 135 and the server 120. In some embodiments, in response to the above notification, establishment of the TCP session between the EN 135 and the server 120 may be started and completed. In some embodiments (for example, when a unique protocol of the overlay network system 130 defines information indicating that a client from which a data payload passing the overlay network system 130 is originated), in response to the above notification, the EN 135 selects a session from a pool of sessions established between the EN 135 and the server 120 in advance. A time taken for such a selection may be shorter than a time taken for establishing a session between the IN 131 and the server 120.

After the TCP session between the client 110 and the IN 131 is established, the client 110 prepares a handshake according to the SSL protocol. For example, in operation 209, the client 110 generates a client side random number that is used to calculate a secure key (for example, a master secret key) for the SSL session. For example, after a predetermined number of random numbers generated in the client 110 at a specific time in advance, at least one of the generated random numbers may be used as necessary (for example, when transmission to the IN 131 is required in operation 211 to be described). The random number generated in advance in this manner may expire after a predetermined time.

In operation 211, the client 110 transmits the generated client side random number to the IN 131. When the client 110 starts an SSL handshake procedure, the client side random number may be transmitted. For example, a client hello message that is one of the SSL handshake protocol messages may include the client side random number as a parameter. Other parameters of the client hello message may include a session ID, a protocol version, and a cipher suite and a compression technique supported by the client 110. The client 110 may transmit the client hello message to the IN 131.

In operation 213, in response to reception of the client hello message, the IN 131 generates a server side random number that is used to calculate a secure key (for example, a master secret key) of an SSL session to be established between the client 110 and the server 120. Similar to the client side random number, after a predetermined number of random numbers are generated in the IN 131 at a specific time in advance, at least one of the generated random numbers may be quickly used as necessary (for example, when transmission to the server 120 is required in operation 215 or 219 to be described). The random number generated in advance in this manner may expire after a predetermined time.

In exemplary embodiments, the IN 131 may transmit the server side random number to the server 120 number through the secure session between the IN 131 and the server 120 established in the above operation 201. For example, as illustrated in FIG. 2A, the IN 131 transmits the server side random number to the EN 135 (operation 215), and the EN 135 may transmit the server side random number to the server 120 (operation 217). As another example, the IN 131 may directly transmit the server side random number to the server 120.

Alternatively, in embodiments in which access established between the IN 131 and the server 120 accompanies a general session (for example, a TCP session), the server side random number may be transmitted from the IN 131 to the server 120 through the general session. The server side random number may be transmitted without encryption from the IN 131 to the server 120 through such a session (that is, a non-secure session). In addition, the IN 131 may encrypt the server side random number as the public key of the server 120 and transmit the result to the server 120 through the session.

The client side random number in the client hello message may be directly bypassed from the IN 131 to the server 120. For example, the client side random number may be transmitted along with the server side random number from the IN 131 to the server 120 through the EN 135 (operations 215 and 217). As another example, the client side random number may be directly transmitted along with the server side random number from the IN 131 to the server 120.

Other parameters of the client hello message may also be directly bypassed from the IN 131 (for example, through the EN 135) to the server 120 (operations 215 and 217).

In operation 219, the IN 131 transmits the server side random number to the client 110. For example, in response to the client hello message, the IN 131 may transmit a server hello message to the client 110. The server hello message may include the server side random number as a parameter. Other parameters of the server hello message may include a session ID, a protocol version of a corresponding client hello message and a cipher suite and a compression technique selected by the IN 131 (for example, based on a cipher suite list received from the server 120). The IN 131 may transmit the server hello message to the client 110.

In operations 221 and 223, the IN 131 transmits the certificate of the server 120 and the public key of the server 120 to the client 110. Then, in operation 225, the IN 131 transmits a server hello done message to the client 110.

Subsequently, the client 110 performs predetermined operations required for establishing the secure session between the client 110 and the server 120 according to an SSL standard. For example, as illustrated in FIG. 2A, in operation 227, the client 110 generates a client side key (for example, a pre-master secret key), and generates a master secret key based on the client side key, the client side random number and the server side random number.

Then, in operation 229, the client 110 encrypts the client side key as the public key of the server 120 in order to establish the SSL session between the client 110 and the server 120 and transmits the result to the IN 131.

In operation 231, the IN 131 calculates the master secret key using the client side random number, the server side random number and the received client side key. The session key and/or a hash key used in the SSL session between the client 110 and the server 120 may be derived from the master secret key.

The IN 131 may transmit the received client side key to the server 120. For example, as illustrated in FIG. 2B, the IN 131 may transmit the encrypted client side key to the server 120 through the EN 135 (operations 233 and 235). As another example, the IN 131 may directly transmit the encrypted client side key to the server 120.

In operation 236, the server 120 may calculate the master secret key using the received client side key as well as the client side random number and the server side random number.

Then, through the following process, establishment of the SSL session between the client 110 and the server 120 is completed. In operation 237, a change cipher spec message indicating that the client 110 will use a cipher spec derived from a cipher suite in the server hello message for the SSL session between the client 110 and the server 120 is transmitted from the client 110 to the IN 131. In addition, in operation 239, a finished message for checking whether a key exchange between the client 110 and the server 120 is successfully performed is transmitted from the client 110 to the IN 131. In response to reception of the change cipher spec message and the finished message from the client 110, in place of the server 120, the IN 131 transmits the change cipher spec message and the finished message to the client 110 (operations 241 and 243).

Meanwhile, the IN 131 transmits the change cipher spec message and the finished message received from the client 110 (for example, through the EN 135) to the server 120 (operations 245, 247, 249 and 251). In response to reception of the change cipher spec message and the finished message from the IN 131, the server 120 transmits its own change cipher spec message and finished message (for example, through the EN 135) to the IN 131 (operations 253, 255, 257 and 259). However, the IN 131 may ignore the change cipher spec message and the finished message received from the server 120. As described above, in operations 241 and 243, in response to reception of the change cipher spec message and the finished message from the client 110, the IN 131 transmitted the change cipher spec message and the finished message to the client 110. Therefore, it may be understood that operations of establishing the SSL session to be performed by the client 110 have already been completed.

Therefore, through the SSL session established between the client 110 and the server 120, the client 110 and the server 120 may perform data communication using the session key. Each of the client 110 and the server 120 may derive the above session key from the master secret key. As described above, the secure session between the client 110 and the server 120 was established, the IN 131 receives application data that is encrypted as the session key from the client 110 (operation 261), and may directly transmit the received application data (for example, through the EN 135) to the server 120 without an operation in which the encrypted application data is decrypted and encrypted as another session key (operations 263 and 265). An operation in which other application data is transmitted from the server 120 to the client 110 does not require that the IN 131 decrypts the application data and encrypts the data as another session key.

Needless to say, the client 110 may transmit application data to the server 120 at a time at which operations of establishing a secure session to be performed by the server 120 are not completed. However, since the IN 131 may serve as a networking queue of a considerable size in the network environment 100, data transmitted from the client 110 at the above time is queued in the IN 131, the secure session between the client 110 and the server 120 is normally established, and then the IN 131 may transmit the application data to the server 120.

FIG. 3 is a diagram illustrating a process of establishing a secure session between a client and a server according to an exemplary embodiment.

Hereinafter, operations of an exemplary process 300 that are different from those of the above-described process 200 will be described in detail and operations similar to those of the process 200 will be briefly described.

In operation 301, the IN 131 establishes a secure access (for example, an SSL session) between the IN 131 and the server 120. The operation 301 may be performed in the same way as the operation 201.

Unlike the process 200, in the process 300, the server 120 and the IN 131 share a mechanism for generating the same OTP (operation 302). For example, in operation 302, the server 120 and the IN 131 may perform an operation of sharing an algorithm for generating the same OTP, a key for generating the same OTP and other share information (for example, a time and a sequence count). Alternatively, in operation 302, the server 120 may activate a mechanism capable of validating the OTP generated by the IN 131.

In operation 303, a TCP session between the client 110 and the IN 131 is established. The operation 303 may be performed in the same way as the operation 203.

In operation 305, the EN 135 is notified of TCP access between the client 110 and the IN 131. In operation 307, in response to the notification, the EN 135 establishes a TCP session with the server 120. Operations 305 and 307 may be performed in the same way as the operations 205 and 207, respectively.

In operation 309, after the TCP session between the client 110 and the IN 131 is established, the client 110 generates a client side random number. The operation 309 may be performed in the same way as the operation 209.

In operation 311, the client 110 transmits the client hello message including the generated client side random number as a parameter to the IN 131. The operation 311 may be performed in the same way as the operation 211.

In operation 313, in response to reception of the client hello message, the IN 131 generates an OTP and derives the server side random number from the generated OTP.

The IN 131 notifies the server 120 that the server side random number has been derived from the OTP (for example, through the EN 135) (operations 314 and 315). In exemplary embodiments, the IN 131 may deliver such a notification to the server 120 through the secure access established between the IN 131 and the server 120. Alternatively, the IN 131 may deliver the notification without encryption to the server 120 through a general non-secure session (for example, a general TCP session) between the IN 131 and the server 120, or may encrypt the notification as the public key of the server 120 and then deliver the result to the server 120 through such a session.

In operation 316, in response to reception of the above notification, the server 120 uses an OTP mechanism shared by the IN 131, generates the same OTP as in the IN 131, and derives the server side random number from the OTP. When the server side random number is derived in this manner, a predetermined method between the server 120 and the IN 131 may be used.

Meanwhile, parameters of the client hello message (including the client side random number) are directly bypassed from the IN 131 (for example, through the EN 135) to the server 120 (operations 317 and 318).

In operation 319, the IN 131 transmits the server hello message including the server side random number as a parameter to the client 110. The operation 319 may be performed in the same way as the operation 219.

In operations 321, 323 and 325, the IN 131 transmits the certificate of the server 120, and the share key of the server 120 and the server hello done message to the client 110. The operations 321, 323 and 325 may be performed in the same way as the operations 221, 223 and 225, respectively.

Then, as described above, the client 110 performs predetermined operations required for establishing the secure session between the client 110 and the server 120 according to the SSL standard. For example, as described above, the client 110 generates the client side key (for example, a pre-master secret key) and calculates the master secret key (operation 327). Subsequently, predetermined operations (for example, operations 229 to 265) illustrated in FIG. 2B may be further performed.

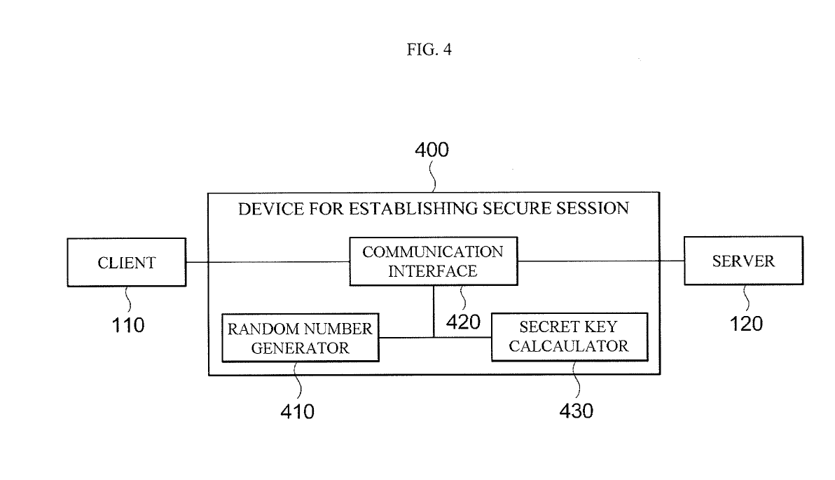

FIG. 4 is a block diagram illustrating a device for establishing a secure session between a client and a server according to an exemplary embodiment.

As illustrated in FIG. 4, an exemplary device for establishing a secure session 400 communicatively accesses the client 110 and the server 120. For example, the device for establishing a secure session 400 may be a computing device that implements the above-described IN 131. Although not illustrated in FIG. 4, at least one other intermediate network node may be disposed between the device for establishing a secure session 400 and the server 120 such that the device for establishing a secure session 400 and the server 120 are communicatively accessed.

The device for establishing a secure session 400 includes a random number generator 410 and a communication interface 420. In addition, the device for establishing a secure session 400 may further include a secret key calculator 430.

In some embodiments, the random number generator 410 may be configured to generate the server side random number in response to reception of the client side random number generated by the client 110. Further, the communication interface 420 may be configured to access the client 110 and the server 120 and deliver information necessary for establishing the secure session (for example, an SSL session) between the client 110 and the server 120 to the client 110 and the server 120. Specifically, the communication interface 420 may be configured to receive the client side random number. The communication interface 420 may be configured to transmit the server side random number to the client 110 and allow the client 110 to calculate a secret key (for example, a master secret key) of a secure session to be established between the client 110 and the server 120. The communication interface 420 may be configured to receive the client side key (for example, a pre-master secret key) used for calculating the secret key. The communication interface 420 may be configured to transmit the client side random number, the server side random number and the client side key to the server 120 and allow the server 120 to calculate the secret key.

In some embodiments, the random number generator 410 may be configured to derive the server side random number from the OTP in response to reception of the client side random number generated by the client 110. Further, the communication interface 420 may be configured to receive the client side random number and transmit the server side random number to the client 110 such that the client 110 calculates a secret key (for example, a master secret key) of a secure session (for example, an SSL session) to be established between the client 110 and the server 120. The communication interface 420 may be configured to transmit a notification indicating that the server side random number is derived to the server and allow the server 120 to generate the same random number as the server side random number that is derived from the random number generator 410 from an OTP that is the same as the OTP. The communication interface 420 may be configured to receive the client side key used for calculating the secret key. In addition, the communication interface 420 may be configured to transmit the client side random number and the client side key to the server 120 and allow the server 120 to calculate the above secret key.

Regardless of whether the server side random number generated by the device for establishing a secure session 400 is transmitted to the server 120, the device for establishing a secure session 400 may have the following additional features. For example, the client side key received from the communication interface 420 may be encrypted by the client 110 as the public key of the server 120. In addition, the server side random number may be transmitted from the communication interface 420 to the server 120 through another secure session that is established between the device for establishing a secure session 400 and the server 120 in advance. Alternatively, the server side random number may be encrypted in the device for establishing a secure session 400 (for example, the communication interface 420) as the public key of the server 120 and then may be transmitted from the communication interface 420 to the server 120. In addition, the server side random number may be transmitted without encryption from the communication interface 420 to the server 120 through a non-secure session established between the device for establishing a secure session 400 and the server 120. The secret key calculator 430 may be configured to calculate the secret key based on the client side random number, the server side random number and the client side key. Further, the device for establishing a secure session 400 may be configured to perform the operations of the IN 131 according to the above-described exemplary processes 200 and 300.

When an overlay networking technique is used, establishment of the secure session between the client 110 and the server 120 described above (for example, the above-described processes 200 and 300) shows better performance than bypass overlay techniques and session separating techniques in the related art.

For example, in the bypass overlay techniques, according to the number of round trips between the client 110 and the server 120 required for establishing a new session, actual data transmission may be performed after a considerable amount of latency elapses. For example, when a round trip time between the client 110 and the server 120 is 250 ms and four round trips are necessary for session establishment, a latency of a minimum of 1000 ms occurs. On the other hand, according to the above-described new overlay networking technique, the IN 131 may be disposed such that a round trip time between the IN 131 and the client 110 is sufficiently short (for example, 40 ms or less) and a round trip time required for session establishment may also be shorter than that of the bypass overlay techniques. Therefore, the overlay networking technique that is improved in this manner may decrease an increase in latency in data transmission.

In addition, the session separating techniques accompany additional decryption and encryption in each of the intermediate network nodes like the IN 131. Therefore, according to the session separating techniques, in order to process one transaction, each intermediate network node should perform decryption twice and encryption twice. When the session separating technique in the related art and the above-described new overlay technique are implemented in the same test environment (in an Intel Core™ 2 Quad CPU Q8300 processor having an operation frequency of 2.50 GHz and a cache of 2048 KB), it was determined that a transaction per second (TPS) processed by the former technique was 20,000 or less and the TPS according to the latter technique was 2,600,000 or less (in this test, in order to prevent the TPS from approaching infinity because there is no encryption or decryption, a minimum memory copy operation was assigned to the two techniques). In other words, the new overlay technique may have a lower cost for receiving an increased service capacity than the session separating technique in the related art.

Further, with reference to the above-described details and FIGS. 2A, 2B and 3, in the exemplary secure session establishing processes 200 and 300, it may be understood that the client 110 does not require a modification of operations to be performed for establishing a secure session according to a security protocol (for example, an SSL protocol) in the related art and operations to be performed by the server 120 may maintain backward compatibility with the above security protocol by only a small modification.

Meanwhile, the embodiments of the present disclosure may include a computer readable recording medium including a program for executing the method of establishing a secure session described in this specification in a computer. The computer readable recording medium may include a program instruction, a local data file, and a local data structure, and/or combinations thereof. The medium may be specially designed and prepared for the present disclosure. Examples of the computer readable recording medium include magnetic media such as a hard disk, a floppy disk, and a magnetic tape, optical media such as a CD-ROM and a DVD, magneto-optical media such as a floptical disk, and a hard device such as a ROM, a RAM, or a flash memory, that is specially made to store and perform the program instruction. Examples of the program instruction may include a machine code generated by a compiler and a high-level language code that can be executed in a computer using an interpreter.

According to predetermined embodiments, transmission of data (for example, real time multimedia data) may be accelerated through an overlay network in which at least one intermediate network node is disposed between a client and a server.

According to predetermined embodiments, latency taken for establishing a secure session for data transmission may decrease.

According to predetermined embodiments, decryption and encryption that are repeatedly performed in the intermediate network node of the overlay network during the data transmission may be avoided.

While representative embodiments of the preset disclosure have been described above in detail, it may be understood by those skilled in the art that the embodiments may be variously modified without departing from the scope of the present disclosure. Therefore, the scope of the present disclosure is defined not by the described embodiment but by the appended claims, and encompasses equivalents that fall within the scope of the appended claims.

What is claimed is:

1. A method of establishing a secure session between a client and a server by a network node accessed by the client and the server, the method comprising:
receiving, by the network node, a client side random number generated by the client;
generating, by the network node, a server side random number in response to reception of the client side random number;
transmitting, by the network node, the server side random number to the client such that the client calculates a secret key of a secure session to be established between the client and the server;
receiving, by the network node, a client side key, used by the client to calculate the secret key, from the client; and
transmitting, by the network node, the client side random number, the server side random number, and the client side key to the server such that the server calculates the secret key.

2. The method of claim 1, further comprising:
calculating, by the network node, the secret key based on the client side random number, the server side random number, and the client side key.

3. The method of claim 1,
wherein the transmitting the server side random number to the server comprises transmitting, by the network node, the server side random number to the server through a secure session that is established between the network node and the server in advance.

4. The method of claim 1,
wherein the transmitting the server side random number to the server comprises encrypting, by the network node, the server side random number as a public key of the server and transmitting the encrypted server side random number to the server.

5. The method of claim 1,
wherein the transmitting the server side random number to the server comprises transmitting, by the network node, the server side random number without encryption to the server through a non-secure session established between the network node and the server.

6. The method of claim 1,
wherein the receiving the client side key comprises receiving, by the network node, the client side key encrypted by the client as a public key of the server.

7. A method of establishing a secure session between a client and a server by a network node accessed by the client and the server, the method comprising:
receiving, by the network node, a client side random number generated by the client;
deriving, by the network node, a server side random number from a one time password (OTP) in response to reception of the client side random number;
transmitting, by the network node, the server side random number to the client such that the client calculates a secret key of a secure session to be established between the client and the server;
transmitting, by the network node, a notification indicating derivation of the server side random number to the server such that the server derives the server side random number from the same OTP;
receiving, by the network node, a client side key, used by the client side to calculate the secret key, from the client; and
transmitting, by the network node, the client side random number and the client side key to the server such that the server calculates the secret key.

8. The method of claim 7, further comprising
calculating, by the network node, the secret key based on the client side random number, the server side random number, and the client side key.

9. The method of claim 7,
wherein the transmitting the notification comprises transmitting, by the network node, the notification to the server through a secure session that is established between the network node and the server in advance.

10. The method of claim 7,
wherein the transmitting the notification comprises encrypting, by the network node, the notification as a public key of the server and transmitting the encrypted notification to the server.

11. The method of claim 7,
wherein the transmitting the notification comprises transmitting, by the network node, the notification without encryption to the server through a non-secure session established between the network node and the server.

12. The method of claim 7,
wherein the receiving the client side key comprises receiving, by the network node, the client side key encrypted by the client as a public key of the server.

13. A device for accessing a client and a server and establishing a secure session between the client and the server, the device comprising:
a random number generator configured to generate a server side random number based on a client side random number generated by the client; and
a communication interface configured to receive the client side random number from the client, transmit the server side random number to the client such that the client calculates a secret key of a secure session to be established between the client and the server, receive a client side key, used by the client to calculate the secret key, from the client, and transmit the client side random number, the server side random number, and the client side key to the server such that the server calculates the secret key.

14. The device of claim 13, further comprising
a secret key calculator configured to calculate the secret key based on the client side random number, the server side random number, and the client side key.

15. The device of claim 13,
wherein the communication interface is configured to transmit the server side random number to the server through a secure session that is established between the device and the server in advance.

16. The device of claim 13,
wherein the communication interface is configured to encrypt the server side random number as a public key of the server and transmit a result of the encryption to the server.

17. The device of claim 13,
wherein the communication interface is configured to transmit the server side random number that is not encrypted to the server through a non-secure session established between the device and the server.

18. The device of claim 13,
wherein the client side key is encrypted by the client as a public key of the server.

19. A device for accessing a client and a server and establishing a secure session between the client and the server, the device comprising:
a random number generator configured to derive a server side random number from a one time password (OTP) based on a client side random number generated by the client; and
a communication interface configured to receive the client side random number from the client, transmit the server side random number to the client such that the client calculates a secret key of a secure session to be established between the client and the server, transmit a notification indicating derivation of the server side random number to the server such that the server derives the server side random number from the same OTP, receive a client side key, used by the client to calculate the secret key, from the client, and transmit the client side random number and the client side key to the server such that the server calculates the secret key.
